(19) United States
(12) Patent Application Publication
(10) Pub. No.: US 2025/0274692 A1
(43) Pub. Date: Aug. 28, 2025

(54) CONTROLLABLE MIST SYSTEM FOR MICROPHONE AND A METHOD THEREOF

(71) Applicants: Manpreet Singh, Rajpura (IN); Mohammad Aljaidi, Zarqa (JO); Manish Kumar Singla, Bathinda (IN); Rabia Emhamed Al Mamlook, Tripoli (LY); Jyoti Gupta, Gurugram (IN); Najat Elgeberi, Las Vegas, NV (US); Abeer Aljohani, AL Madinah (SA); Saad Aljohani, Kalamazoo, MI (US)

(72) Inventors: Manpreet Singh, Rajpura (IN); Mohammad Aljaidi, Zarqa (JO); Manish Kumar Singla, Bathinda (IN); Rabia Emhamed Al Mamlook, Tripoli (LY); Jyoti Gupta, Gurugram (IN); Najat Elgeberi, Las Vegas, NV (US); Abeer Aljohani, AL Madinah (SA); Saad Aljohani, Kalamazoo, MI (US)

(21) Appl. No.: 19/208,650

(22) Filed: May 15, 2025

Related U.S. Application Data
(60) Provisional application No. 63/642,249, filed on May 3, 2024.

(30) Foreign Application Priority Data
Apr. 2, 2025 (IN) 202511032787

(51) Int. Cl. H04R 1/02; B05B 11/10; F24F 5/00; H04R 1/08

(52) U.S. Cl. CPC H04R 1/028; B05B 11/10; F24F 5/0035; H04R 1/08

(57) ABSTRACT

In an aspect of the present disclosure, a controllable mist system (100) for microphone and a method (200) thereof are disclosed. The system (100) includes a storage tank (102) that is connected to a receiver (106) of the microphone (150) and has a centrifugal pump (not shown) to trigger and provide controlled water supply from the storage tank (102) after a pre-defined time interval to a nozzle jet (104) to disperse water in the form of mist in controlled bursts. The system (100) provides a customized nozzle jet (104) to control various parameters for mist dispersal before dispersal of misting, during session of misting and post dispersal to provide periodic misting to fulfil hydration and environmental cooling required for the speaker while lecture.

### FIELD OF THE DISCLOSURE

The present disclosure generally relates to Electrical systems. More specifically, the present disclosure relates to a controllable mist system for microphone and a method thereof.

### BACKGROUND

The problem at hand revolves around the strain and dehydration experienced by speakers during lectures, posing a significant threat to vocal health. Prolonged speaking without adequate hydration can lead to vocal fatigue, diminished voice quality, and potential long-term damage to the vocal cords. This issue is particularly pronounced in educational and professional settings where speakers often engage in extended periods of verbal communication. The lack of a tailored solution to address vocal hydration during lectures exacerbates the risk of voice-related problems.

Other potential solutions to address vocal health during speaking engagements include such as traditional throat lozenges or sprays, portable humidifiers, water bottles, throat hydration monitoring devices, voice training, and built-in microphone hydration systems. However, such alternatives have certain limitations associated therewith.

Throat lozenges and sprays provide only short-term relief and may be distracting. Portable humidifiers may not offer targeted moisture while water bottles may interrupt presentations. Throat hydration monitoring devices may be challenging to develop. Voice training is a long-term approach, and built-in microphone hydration systems may be complex and affect microphone performance.

Therefore, there is a need for developing alternatives to get rid of aforementioned prior arts.

### OBJECTS OF THE PRESENT DISCLOSURE

An object of the present disclosure is to provide a controllable mist system for microphone.

Another object of the present disclosure is to provide the controllable mist system which provides a unique combination of targeted misting, seamless integration with the microphone, and user-controlled customization, aiming to provide a more comprehensive and adaptable solution to the challenges faced by speakers during prolonged speaking engagements.

Another object of the present disclosure is to provide the controllable mist system which enables speakers to have personalized control over both the timing and quantity of the mist.

Another object of the present disclosure is to provide the controllable mist system which enables the speakers to adjust the mist output based on factors including such as but not limited to room humidity, their own vocal condition, or the duration of the speaking engagement.

Another object of the present disclosure is to provide the controllable mist system which is easy to use and reduces the need for additional equipment or complicated setups.

Another object of the present disclosure is to provide the controllable mist system which facilitates an efficient way to maintain optimal moisture levels, reducing the risk of strain and fatigue.

Another object of the present disclosure is to provide a method (200) for providing periodic and optimal misting to a speaker during a lecture

### SUMMARY

In an embodiment, the present disclosure discloses a controllable mist system (100) for microphone (150). The system (100) includes a storage tank (102) to store water to produce mist therefrom. The storage tank (102) is connected to a receiver (106) of the microphone (150) wherein size of the storage tank (102) adjustable based on speaker's preferences and expected duration of speaker engagement. A centrifugal pump (not shown) in the storage tank (102) is configured to trigger and provide controlled water supply from the storage tank (102) after a pre-defined time interval to a nozzle jet (104). A network of pipes (112) includes a first pipe (112A) connecting a mic (116) and the storage tank (102), and a second pipe (112B) connecting the storage tank (102) to an edge of the mic (116) through a cantilever (118). The nozzle jet (104) at terminal free end of the second pipe (112B) to disperse water in the form of mist in controlled bursts. The user controls (108) include mechanical buttons to enable the speaker to regulate the system (100). The microcontroller (120) is associated with a plurality of subunits. The system (100) provides a customized nozzle jet (104) to control various parameters for mist dispersal before dispersal of misting, during session of misting and post dispersal to provide periodic misting to fulfil hydration and environmental cooling required for the speaker while lecture.

In another embodiment, the present disclosure discloses a method (200) for providing periodic and optimal misting to a speaker during a lecture. The method (200) involves receiving user defined input where the input comprising defining pulse interval for dispersion of the mist, intensity of the mist through the user controls (108), followed by providing haptic feedback to alert a speaker before initiating release of the mist, which activates at pre-defined time interval. The method (200) further involves triggering a centrifugal pump (102B) to draw water from the storage tank (102) by sending a signal thereto to deliver water to the nozzle jet (108), followed by pushing the water to a nozzle jet (104) which further disperses the water in the form of mist, and causing the centrifugal pump to return to an idle state until the next pulse.

### BRIEF DESCRIPTION OF THE DRAWINGS

Other objects, features, and advantages of the embodiment will be apparent from the following description when read with reference to the accompanying drawings. In the drawings, reference numerals denote corresponding parts throughout the several views:

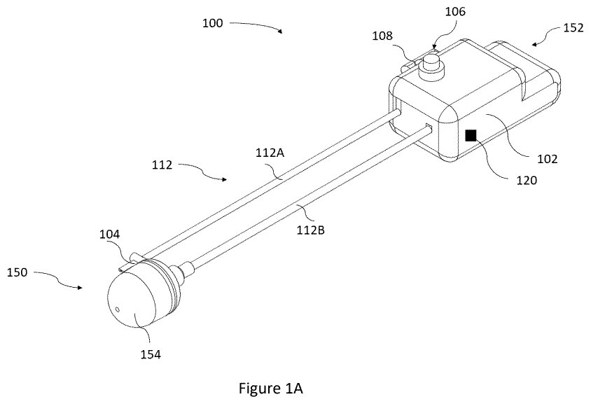

Referring to FIG. 1A, shows a schematic perspective view of a controllable mist system (100) for microphone, in accordance with an illustrative embodiment of a present disclosure;

Referring to FIG. 1B, shows another schematic perspective view of the controllable mist system (100) for microphone, in accordance with the illustrative embodiment of a present disclosure;

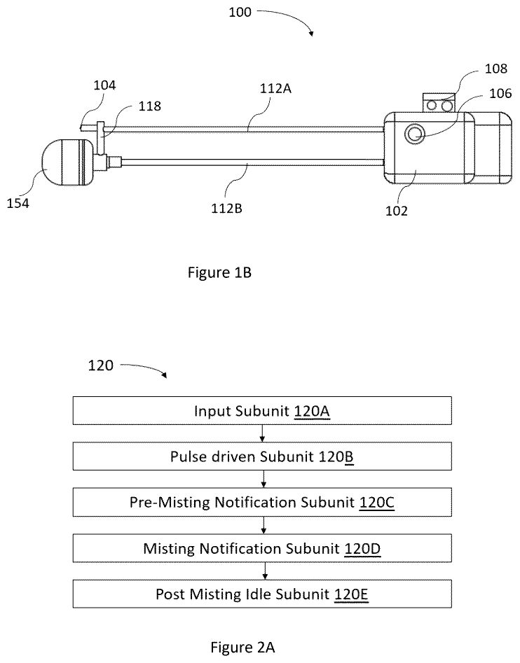

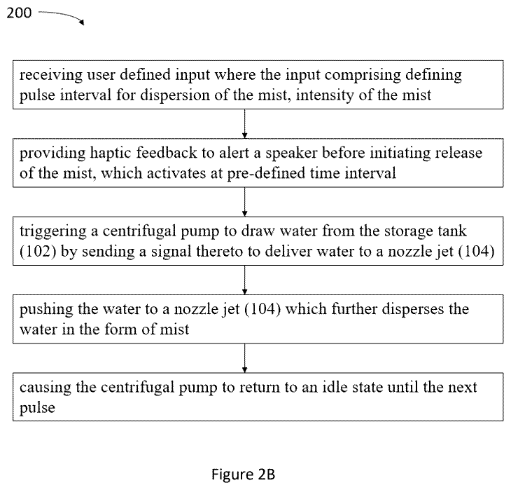

Referring to FIG. 2A, shows various subunits associated with a microcontroller (120), in accordance with the illustrative embodiment of the present disclosure; and

Referring to FIG. 2B, shows a flowchart depicting steps of method (200) for providing periodic and optimal misting to a speaker during a lecture, in accordance with another illustrative embodiment of the present disclosure.

### DETAILED DESCRIPTION OF THE PREFERRED EMBODIMENTS

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Many modifications will be apparent to those skilled in the art without departing from the scope of the present invention as hereinbefore described with reference to the accompanying drawings.

Where a definition or use of a term in an incorporated reference is inconsistent or contrary to the definition of that term provided herein, the definition of that term provided herein applies and the definition of that term in the reference does not apply.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As used herein, the singular forms “a”, “an”, and “the” include plural referents unless the context clearly dictates otherwise. Further, the terms “like”, “as such”, “for example”, and “including” are meant to introduce examples that further clarify the more general subject matter, and should be contemplated for the persons skilled in the art to understand the subject matter.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The present disclosure generally relates to a controllable mist system (100) for microphone (150). As shown in FIGS. 1A and 1B, the system (100) includes a storage tank (102) to store water to produce mist therefrom. The storage tank (102) is connected to a receiver (106) of the microphone (150). Size of the storage tank (102) is adjustable based on speaker's preferences and expected duration of speaker engagement. The storage tank (102) employs a modular design with a base unit of exemplary 200 ml capacity and expandable extension segments of exemplary 100 ml each. The system (100) allows speakers to customize capacity by removing microphone attachment, unlocking the base segment through a quarter-turn mechanism, then adding or removing extension segments as needed. Each segment connects via watertight seals and quick-release locks. The tank (102) includes water level sensors that automatically recalibrate for different configurations, while a centrifugal pump system auto-adjusts pressure to maintain consistent performance regardless of tank size. This modular approach allows expansion up to 1.5 L total capacity, with each 100 ml extension providing approximately 15-20 minutes of additional misting time. The centrifugal pump (not shown) in the storage tank (102) to trigger and provide controlled water supply from the storage tank (102) after a pre-defined time interval to a nozzle jet (104). The controlled water supply is achieved through an integrated system of precision components. A variable speed centrifugal pump works in conjunction with a flow rate sensor and electronic control valve to maintain precise water output. A pressure regulator ensures consistent water pressure regardless of tank level, while a microcontroller-based feedback system continuously monitors and adjusts the flow based on user settings. This combination allows for fine-tuned control over water output, from gentle mist to more substantial spray patterns, all while maintaining consistent pressure and flow rates.

As shown in FIG. 1B, there is a network of pipes (112) having two pipes—a first pipe (112A) and a second pipe (112B). The first pipe (112A) connects a mic (116) with the storage tank (102). The first pipe (112A) serves as both a structural support element and houses the electrical connections between the microphone and storage tank, effectively reducing the overall bulk of the system while maintaining necessary functionality. The second pipe (112B) is configured to connect the storage tank (102) to an edge of the mic (116) through a cantilever (118). The second pipe (112B) is dedicated to water transport, carrying water from the storage tank to the nozzle jet through the cantilever support system. This separation of functions ensures electrical components remain isolated from water flow while maintaining structural integrity.

The nozzle jet (104) is at terminal free end of the second pipe (112B) to disperse water in the form of mist in controlled bursts. The controlled burst release is managed through a sophisticated valve system. There is a solenoid valve, controlled by an electronic timing circuit, precisely regulates water release. This works in conjunction with a pressure accumulator that ensures consistent burst pressure regardless of tank water level. A microcontroller (120) coordinates these components to deliver precise burst patterns according to user settings. The system (100) includes feedback sensors that monitor and adjust burst intensity and duration in real-time. The pulse system utilizes a crystal oscillator-based timing circuit for highly accurate interval control. This generates programmable pulse width modulation signals that regulate water flow. The microcontroller processes user inputs from the control interface to adjust pulse timing and intensity. A feedback loop monitors system performance to maintain consistent pulse patterns, while the electronic control system can adjust pulse characteristics based on environmental conditions and user preferences. Users can adjust misting parameters through a combination of digital and mechanical controls. The system (100) includes digital potentiometers for intensity control, touch-sensitive sliders for flow rate adjustment, and preset buttons for common patterns. The hardware interface combines a 2.4-inch LCD touch screen with mechanical controls, allowing users to fine-tune mist dispersion patterns, timing intervals, and intensity levels. The nozzle jet itself features adjustable spray patterns controlled by the microcontroller based on user inputs.

The microphone receiver (106) integrates with the storage tank through a custom-designed mounting bracket system. This includes vibration-dampening gaskets to prevent unwanted vibration transfer, a quick-release mechanism for easy maintenance access, and a waterproof sealing system to protect electrical components. The mounting system ensures secure attachment while maintaining easy access for adjustments and maintenance.

There are user controls (108) that include mechanical buttons such as push buttons to enable the speaker to regulate the system (100). The user controls (108) have to be in vicinity to the speaker for quick reachability. The push button mechanism uses a waterproof IP67-rated momentary switch with an LED indicator ring for visual feedback. When pressed for ON, the signal goes through a debounce circuit to prevent false triggers, then activates a latching circuit that triggers the Power Management IC (PMIC). The PMIC performs a soft-start sequence: powering the microcontroller, initializing sensors, and performing system checks, while the LED shows solid blue to indicate activation.

For OFF, pressing the button initiates a shutdown sequence that stops the pump, drains residual water from pipes, deactivates sensors, and cuts power. The system includes safety features like emergency shutoff protection for abnormal conditions and surge protection during startup. The waterproof design and controlled shutdown sequence ensure reliable operation while protecting the system's components.

As shown in FIG. 2A, the microcontroller (120) is associated with a plurality of subunits. The subunits include such as but not limited to an input subunit (120A), a pulse-driven subunit (120B), a pre-misting notification subunit (120C); a misting subunit (120D); a post-misting idle subunit (120E).

The input subunit (120A) is configured to receive user defined input where the input comprising defining pulse interval for dispersion of the mist, intensity of the mist through the user controls (108).

The pulse-driven subunit (120B) is configured to trigger the centrifugal pump by sending a signal thereto to deliver water to the nozzle jet (108). The pre-misting notification subunit (120C) to alert the speaker before initiation of the mist dispersal. A vibrator (not shown) is to provide haptic feedback to the pre-misting notification subunit (120C) to notify a speaker before initiating release of the mist, which activates at pre-defined time interval.

The misting subunit (120D) is configured to regulate the centrifugal pump to draw water from the storage tank (102) and push the water to the nozzle jet (104) which further disperses the water in the form of mist based on various parameters. The parameters for mist dispersal include such as but not limited to timing of mist, quantity of the mist, dispersion pattern, turn ON or OFF, intensity, intervals in real time through the user controls (108). The post-misting idle subunit (120E) to cause the centrifugal pump to return to an idle state until the next pulse. The post-misting idle subunit (120E) manages the centrifugal pump's transition to and maintenance of its idle state through a sophisticated control sequence. When a misting cycle completes, the microcontroller (120) initiates a carefully controlled deactivation process by sending a shutdown signal to the pump driver. This signal gradually reduces the PWM (Pulse Width Modulation) output to minimize mechanical stress on the pump components. During this reduction, current monitoring ensures the pump decelerates smoothly while pressure sensors verify proper system depressurization.

To prepare for the next pulse, the post-misting idle subunit (120E) maintains the system at optimal temperature and pressure equilibrium. It keeps ready state indicators active and maintains quick-start capability, allowing for immediate response when the next misting cycle is triggered. This approach not only protects the pump's mechanical components but also ensures consistent, reliable performance across multiple misting cycles while maximizing energy efficiency and system longevity.

Hence, the system (100) provides a customized nozzle jet (104) to control various parameters for mist dispersal before dispersal of misting, during session of misting and post dispersal to provide periodic misting to fulfil hydration and environmental cooling required for the speaker while lecture. The system (100) is automated and requires no user intervention, seamlessly transitioning between active misting and idle states based on the programmed intervals. This sophisticated control system (100) ensures reliable operation while protecting the equipment and maintaining optimal performance readiness. The system (100) includes AC or DC power source to run the system (100).

FIG. 2B discloses a flowchart depicting a method (200) for providing periodic and optimal misting to a speaker during a lecture. The method (200) involves receiving user defined input where the input comprising defining pulse interval for dispersion of the mist, intensity of the mist through the user controls (108), followed by providing haptic feedback to alert a speaker before initiating release of the mist, which activates at pre-defined time interval. The method (200) further involves triggering a centrifugal pump (102B) to draw water from the storage tank (102) by sending a signal thereto to deliver water to the nozzle jet (108), followed by pushing the water to a nozzle jet (104) which further disperses the water in the form of mist, and causing the centrifugal pump to return to an idle state until the next pulse.

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiments were chosen and described in order to best explain the principles of the disclosure and its practical application, to thereby enable others skilled in the art to best utilize the disclosure and various embodiments with various modifications as are suited to the particular use contemplated.

We claim:

1. A controllable mist system (100) for microphone (150), the system (100) comprising:
a storage tank (102) to store water to produce mist therefrom, the storage tank (102) connected to a receiver (106) of the microphone (150) wherein size of the storage tank (102) adjustable based on speaker's preferences and expected duration of speaker engagement;
a centrifugal pump (not shown) in the storage tank (102) to trigger and provide controlled water supply from the storage tank (102) after a pre-defined time interval to a nozzle jet (104);
a network of pipes (112) comprising a first pipe (112A) connecting a mic (116) and the storage tank (102), and a second pipe (112B) connecting the storage tank (102) to an edge of the mic (116) through a cantilever (118);
the nozzle jet (104) at terminal free end of the second pipe (112B) to disperse water in the form of mist in controlled bursts;
user controls (108) comprising mechanical buttons to enable the speaker to regulate the system (100);
the microcontroller (120) associated with a plurality of subunits, the subunits comprising:
an input subunit (120A) to receive user defined input where the input comprising defining pulse interval for dispersion of the mist, intensity of the mist through the user controls (108);
a pulse-driven subunit (120B) to trigger the centrifugal pump by sending a signal thereto to deliver water to the nozzle jet (108);
a pre-misting notification subunit (120C) to alert the speaker before initiation of the mist dispersal;
a misting subunit (120D) to regulate the centrifugal pump to draw water from the storage tank (102) and push the water to the nozzle jet (104) which further disperses the water in the form of mist;
a post-misting idle subunit (120E) to cause the centrifugal pump to return to an idle state until the next pulse;
wherein the system (100) provides a customized nozzle jet (104) to control various parameters for mist dispersal before dispersal of misting, during session of misting and post dispersal to provide periodic misting to fulfil hydration and environmental cooling required for the speaker while lecture.

2. The system (100) as claimed in claim 1, wherein the parameters for mist dispersal comprising timing of mist, quantity of the mist, dispersion pattern, turn ON or OFF, intensity, intervals in real time through the user controls (108).

3. The system (100) as claimed in claim 1, wherein the system (100) comprising a microphone receiver (106) integrated seamlessly with the storage tank (102) such that the system (100) keeps away from the receiver (106).

4. The system (100) as claimed in claim 1, wherein the system (100) comprising AC or DC power source to run the system (100).

5. The system (100) as claimed in claim 1, wherein the centrifugal pump receives signals from the microcontroller.

6. The system (100) as claimed in claim 1, wherein a vibrator (not shown) to provide haptic feedback to the pre-misting notification subunit (120C) to notify a speaker before initiating release of the mist, which activates at pre-defined time interval.

7. The system (100) as claimed in claim 1, wherein the system (100) comprising a touch display interface to control intensity of the mist.

8. A method (200) for providing periodic and optimal misting to a speaker during a lecture, the method (200) comprising:
receiving user defined input where the input comprising defining pulse interval for dispersion of the mist, intensity of the mist through the user controls (108);
providing haptic feedback to alert a speaker before initiating release of the mist, which activates at pre-defined time interval;
triggering a centrifugal pump (102B) to draw water from the storage tank (102) by sending a signal thereto to deliver water to the nozzle jet (108);
pushing the water to a nozzle jet (104) which further disperses the water in the form of mist; and
causing the centrifugal pump to return to an idle state until the next pulse.
